(19) United States
(12) Patent Application Publication
(10) Pub. No.: US 2013/0291820 A1
(43) Pub. Date: Nov. 7, 2013

(54) GLOW PLUG WITH COMBUSTION PRESSURE SENSOR

(71) Applicants: Tadashi Watanabe, Komaki-city (JP); Shunsuke Maeda, Toyota-city (JP); Yoshihiro Nakamura, Iwakura-city (JP); Masayoshi Matsui, Ichinomiya-city (JP)

(72) Inventors: Tadashi Watanabe, Komaki-city (JP); Shunsuke Maeda, Toyota-city (JP); Yoshihiro Nakamura, Iwakura-city (JP); Masayoshi Matsui, Ichinomiya-city (JP)

(73) Assignee: NGK SPARK PLUG CO., LTD., Nagoya-shi, Aichi (JP)

(21) Appl. No.: 13/979,240

(22) PCT Filed: Feb. 21, 2012
(86) PCT No.: PCT/JP2012/001134

§ 371 Date: Jul. 11, 2013

(30) Foreign Application Priority Data
Feb. 25, 2011 (JP) 2011-039114

(51) Int. Cl. F02B 77/00

(52) U.S. Cl. CPC F02B 77/005
USPC 123/145 A

(57) ABSTRACT

A glow plug with a combustion pressure sensor is improved in airtightness between the same and a combustion chamber. The glow plug 100 includes a housing having a substantially tubular metallic shell extending in an axial direction and a substantially tubular cap member which is provided at the front end of the metallic shell, which is shorter in length along the axial direction than the metallic shell, and whose diameter decreases toward the front end thereof, a heater unit, a connecting member, and a pressure sensor. The cap member is formed of a material higher in tensile strength or yield strength than a material used to form the metallic shell, and the metallic shell is formed of a material higher in thermal expansion coefficient than that used to form the cap member.

### TECHNICAL FIELD

The present invention relates to a glow plug and particularly to a glow plug with a combustion pressure sensor.

### BACKGROUND ART

Glow plugs are used as auxiliary heat sources in compression-ignition-type internal combustion engines, such as diesel engines. For example, the glow plugs described in Patent Documents 1 and 2 establish airtightness of the combustion chambers as follows: external threads provided on a housing are engaged with internal threads of a plug attachment hole formed in the engine head of an internal combustion engine, and a tapered seal surface provided at a front end of the housing is brought in contact with a tapered seat surface formed around the plug attachment hole of the internal combustion engine.

However, in recent years, in addition to the conventional diffusion combustion type, new combustion types, such as premix combustion type, have been proposed; accordingly, the combustion pressures of internal combustion engines tend to increase. Thus, conventional glow plugs may encounter difficulty in ensuring sufficient airtightness at increased combustion pressures. Particularly, since a glow plug equipped with a pressure sensor for detecting combustion pressure in an internal combustion engine is required to incorporate therein a structure for allowing movement of a sensor and a heater (a structure for allowing displacement relative to a housing), difficulty is encountered in increasing the thickness of the housing. Therefore, in view of possibility of plastic deformation or the like of the housing, difficulty is encountered in improving airtightness between the glow plug and a combustion chamber merely through increase of axial force for fastening the glow plug. Also, in many cases, an engine head to which a glow plug is attached is formed of aluminum or a like metal having high thermal expansion coefficient. Thus, as the temperature of the internal combustion engine increases, the engine head expands, thereby raising a problem of reduction in the axial force of the glow plug.

### PRIOR ART DOCUMENTS

### Patent Documents

Patent Document 1: Japanese Patent Application Laid-Open (kokai) No. 2004-205148
Patent Document 2: Japanese Patent Application Laid-Open (kokai) No. 2002-276942

### SUMMARY OF THE INVENTION

### Problem to be Solved by the Invention

In view of the foregoing problem, an object to be achieved by the present invention is to provide a glow plug with a combustion pressure sensor (hereinafter may be referred to as a “combustion pressure sensor-equipped glow plug”) having improved airtightness between the same and a combustion chamber.

### Means for Solving the Problem

The present invention has been conceived to solve, at least partially, the above problem and can be embodied in the following modes or application examples.

### Application Example 1

A combustion pressure sensor-equipped glow plug comprising a housing having a tubular metallic shell extending in an axial direction and a tubular cap member which is provided at a front end of the metallic shell, which is shorter in length along the axial direction than the metallic shell, and whose diameter decreases toward a front end thereof; a rod-shaped heater unit having a rear end disposed within the housing and a front end protruding from the front end of the cap member, the heater unit being movable in the axial direction; a connecting member which connects the heater unit to the housing and allows the heater unit to move in the axial direction; and a pressure sensor which detects combustion pressure according to load transmitted via the heater unit, the combustion pressure sensor-equipped glow plug being characterized in that the cap member is formed of a material higher in tensile strength or yield strength than a material used to form the metallic shell, and the metallic shell is formed of a material higher in thermal expansion coefficient than that used to form the cap member.

### Application Example 2

A combustion pressure sensor-equipped glow plug according to application example 1, wherein the cap member has a cylindrical portion formed at a rear end thereof, and the thickness of the metallic shell is greater than the thickness of the cylindrical portion.

### Application Example 3

A combustion pressure sensor-equipped glow plug according to application example 2, wherein an inside diameter of the cylindrical portion is greater than an inside diameter of the metallic shell, and the connecting member is disposed in the cylindrical portion.

In addition to implementation of the present invention in the combustion pressure sensor-equipped glow plug configured as mentioned above, the present invention can also be implemented in a method of manufacturing the combustion pressure sensor-equipped glow plug, and in an internal combustion engine to which the combustion pressure sensor-equipped glow plug is attached.

### ADVANTAGEOUS EFFECTS OF THE INVENTION

In the glow plug having the configuration of application example 1, since the cap member is formed of a material higher in tensile strength or yield strength than a material used to form the metallic shell, rigidity can be enhanced for the cap member on which stress generated as a result of fastening is concentrated. Also, since the metallic shell longer than the cap member is formed of a material higher in thermal expansion coefficient than that used to form the cap member, thermal expansion of the glow plug can follow that of an engine head. By virtue of these features, even in the case of high combustion pressure in a combustion chamber or high thermal expansion coefficient of the engine head, airtightness between the combustion chamber and the glow plug can be ensured without need to excessively increase initial fastening axial force.

In the configuration of application example 2, since the metallic shell is greater in thickness than the cylindrical portion provided at the rear end of the cap member, rigidity can be enhanced for the metallic shell lower in tensile strength or yield strength than the cap member.

In the configuration of application example 3, since the connecting member is disposed in the cap member's cylindrical portion which is greater in inside diameter and smaller in thickness than the metallic shell, the area of the connecting member can be increased as compared with the case of disposition of the connecting member in the metallic shell. Accordingly, the range of movement of the heater unit can be increased, whereby the performance of the pressure sensor can be improved.

### BRIEF DESCRIPTION OF THE DRAWINGS

FIG. 1 Set of diagrams illustrating the structure of a glow plug according to one embodiment of the present invention.

FIG. 2 Enlarged cross-sectional view of a cap member and its vicinity.

### MODES FOR CARRYING OUT THE INVENTION

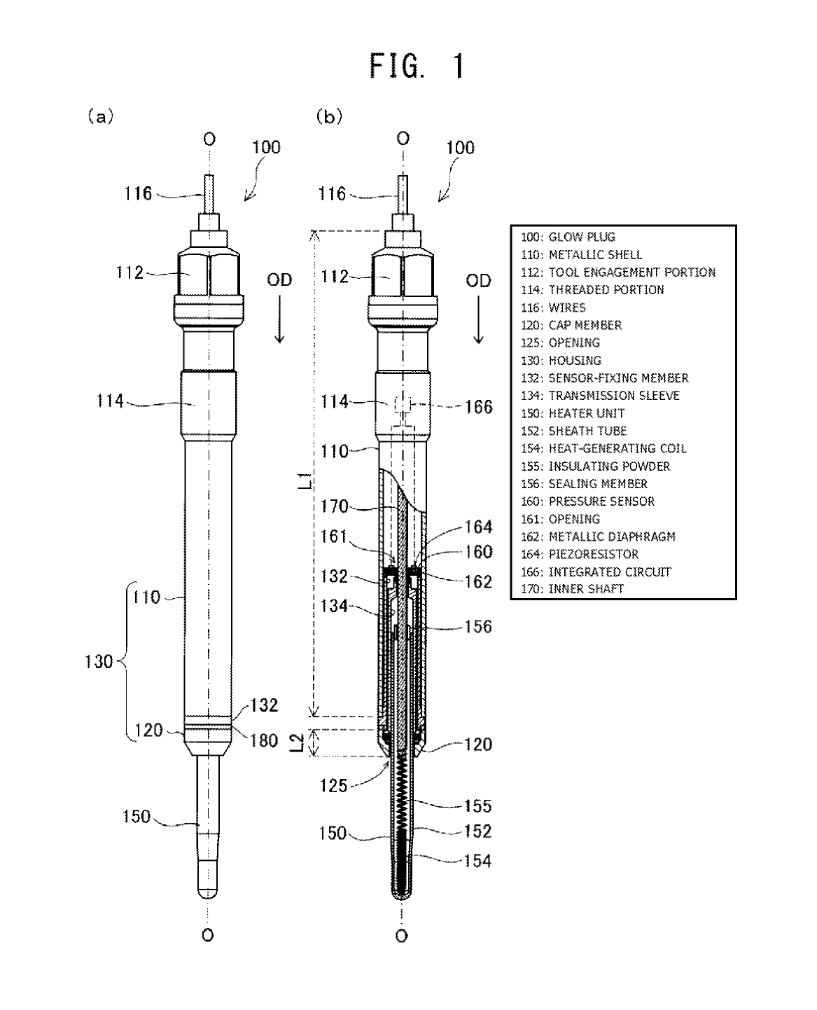

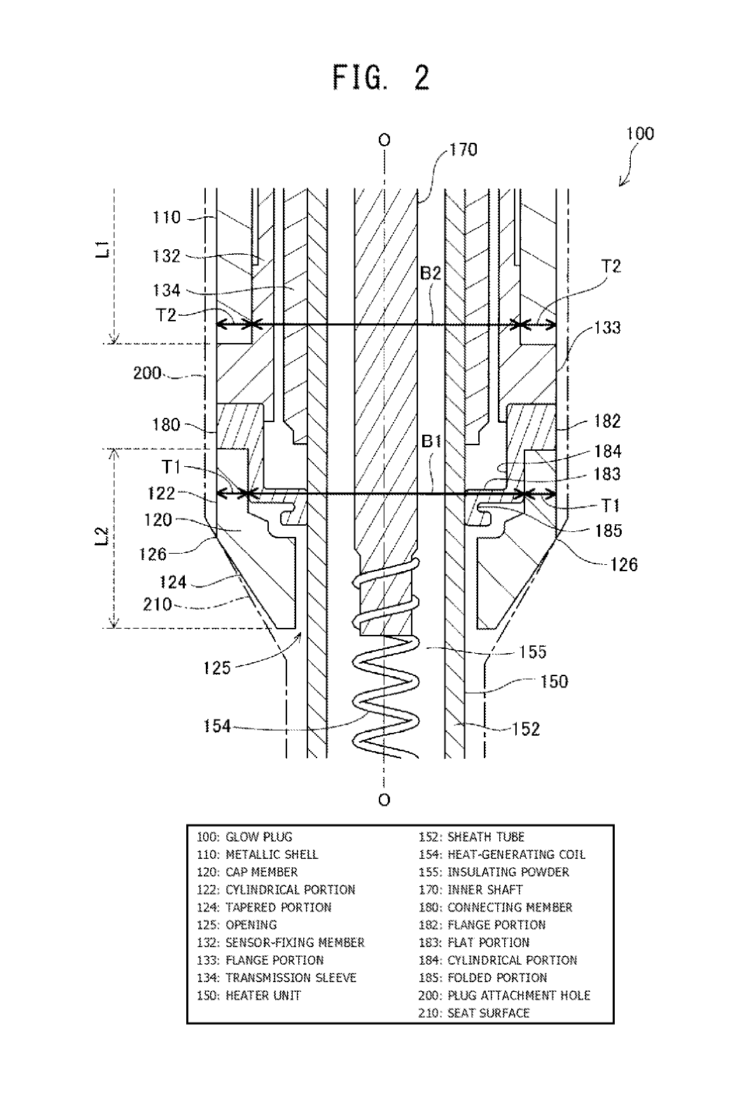

FIG. 1 is a set of diagrams illustrating the structure of a glow plug 100 according to one embodiment of the present invention. FIG. 1(a) shows the overall structure of the glow plug 100, and FIG. 1(b) is a partially sectional view showing the structure. FIG. 2 is an enlarged cross-sectional view of a cap member 120 to be described later and its vicinity. In the following description, the lower side of the glow plug 100 along an axis O in FIGS. 1 and 2 is referred to as the front side of the glow plug 100, and the upper side is referred to as the rear side. In addition, a downward direction along the axis O of the glow plug 100 is referred to as an axial direction OD. As shown in FIGS. 1(a) and 1(b), the glow plug 100 includes a housing 130 having a metallic shell 110 and a cap member 120, and a heater unit 150.

The metallic shell 110 is a substantially cylindrical metallic member. In the present embodiment, the metallic shell 110 is formed of a high-thermal-expansion metal. In the present embodiment, a high-thermal-expansion metal refers to a metal having a tensile strength of 600 MPa or less and a thermal expansion coefficient of 14 ppm/° C. or more in a temperature range of −40° C. to 150° C.; for example, an austenitic stainless steel, such as SUS304, SUS303, or SUS316, can be used. A length L1 of the metallic shell 110 along the axial direction OD is longer than a length L2 of the cap member 120; for example, the length L1 can be 40 mm or more.

A tool engagement portion 112 for engagement with a tool for attaching the glow plug 100 to an internal combustion engine is formed at the rear end of the metallic shell 110, and a threaded portion 114 having a thread groove (not shown) formed therein to secure the glow plug 100 to a cylinder head is provided frontward of the tool engagement portion 112. A plurality of wires 116 electrically connected to an integrated circuit 166 (described later) and an inner shaft 170 (described later) that are disposed in the housing 130 are inserted from the rear end of the tool engagement portion 112.

The cap member 120 is an annular metal member and is disposed at the front end of the metallic shell 110. As shown in FIG. 2, the cap member 120 has a cylindrical portion 122 which is formed on its rear side and which maintains a substantially fixed outer diameter; and a tapered portion 124 which is formed on the front side and which is tapered such that the diameter decreases toward the front end thereof. Length L2 of the cap member 120 along the axial direction OD is shorter than length L1 of the metallic shell 110 and can be, for example, 15 mm or less. In the present embodiment, the cap member 120 is formed of a high-strength metal having high tensile strength (or high yield strength). In the present embodiment, the high-strength metal refers to a metal having a thermal expansion coefficient of less than 14 ppm/° C. and a tensile strength of 800 MPa or more in a temperature range of −40° C. to 300° C.; for example, SUS630 (precipitation hardening stainless steel), INCONEL (registered trademark) 718, or maraging steel can be used. Also, in the present embodiment, thickness T1 of the cylindrical portion 122 of the cap member 120 is smaller than thickness T2 of the metallic shell 110 as measured at a position located frontward of the threaded portion 114, and inside diameter B1 of the cylindrical portion 122 is greater than inside diameter B2 of the metallic shell 110. The thickness T1 can be, for example, 0.5 mm to 1.0 mm, and the thickness T2 can be 0.7 mm to 1.2 mm. When the glow plug 100 is attached to an internal combustion engine, a circumferential corner 126 of the cap member 120 comes into contact with a seat surface 210 of a plug attachment hole 200 of an engine head. The contact (line contact) between the corner 126 and the seat surface 210 maintains airtightness between a combustion chamber and the exterior of the engine head.

The heater unit 150 includes a sheath tube 152, a heat-generating coil 154, and an insulating powder 155. The sheath tube 152 is formed of, for example, stainless steel having high heat resistance and high corrosion resistance. As shown in FIG. 1, the sheath tube 152 has a closed hemispherical front end and an open rear end located within the metallic shell 110. The heat-generating coil 154 is a wire-wound resistor and is disposed inside the sheath tube 152 at the front end thereof. The inner shaft 170 (a rod-like member made of metal) is inserted into the heater unit 150, and the rear end of the heat-generating coil 154 is connected to the front end of the inner shaft 170. Electric power is externally supplied to the heat-generating coil 154 through one of the wires 116 and the inner shaft 170. The space between the sheath tube 152 and the heat-generating coil 154 is filled with the insulating powder 155, which is powder of a heat resisting material such as magnesium oxide. A sealing member 156 for confining the insulating powder 155 in the sheath tube 152 is inserted into the gap between the open rear end of the sheath tube 152 and the inner shaft 170. The sheath tube 152 has been subjected to swaging. This improves the denseness of the insulating powder 155 filling the sheath tube 152, and the efficiency of heat conduction is thereby improved. The heater unit 150 having the above configuration is disposed such that its rear end is disposed within the metallic shell 110 and the front end protrudes from an opening 125 of the cap member 120 in the axial direction OD.

The housing 130 contains an annular pressure sensor 160 disposed rearward of the heater unit 150, a sensor-fixing member 132 for fixing the pressure sensor 160 to the housing 130, a transmission sleeve 134 for transmitting displacement of the heater unit 150 along the axis O or load generated as a result of the displacement to the pressure sensor 160, and the connecting member 180 for connecting the outer circumference of the heater unit 150 to the inner side of the housing 130.

The sensor-fixing member 132 is a substantially cylindrical member formed of, for example, stainless steel. The sensor-fixing member 132 is disposed along the inner circumference of the metallic shell 110 and has a collar-shaped flange portion 133 formed at the front end of the sensor-fixing member 132. The flange portion 133 is welded to the front end surface of the metallic shell 110. The outer circumference of the pressure sensor 160 is welded to the rear end of the sensor-fixing member 132. In this embodiment, the sensor-fixing member 132 holds the pressure sensor 160 at a position near the central portion of the housing 130.

The transmission sleeve 134 is a substantially cylindrical member formed of, for example, stainless steel. The transmission sleeve 134 is disposed between the sensor-fixing member 132 and the heater unit 150. The front end of the transmission sleeve 134 is welded to the outer circumference of the heater unit 150 at a position near the flange portion 133 of the sensor-fixing member 132. The rear end of the transmission sleeve 134 is welded to the inner circumference of the annular pressure sensor 160. The displacement of the heater unit 150 along the axis O or load generated as a result of the displacement is transmitted to the inner circumference of the pressure sensor 160 through the transmission sleeve 134.

The connecting member 180 (see FIG. 2) is an elastic annular member formed of, for example, stainless steel or a nickel alloy. The connecting member 180 includes a collar-shaped flange portion 182 disposed at its rear end, a thin-film-like flat portion 183 disposed at the front end, and a cylindrical portion 184 connecting the flange portion 182 to the flat portion 183. The upper surface (the rear end surface) of the flange portion 182 is welded to the flange portion 133 of the sensor-fixing member 132, and the lower surface (the front end surface) of the flange portion 182 is welded to the rear end surface of the cap member 120. As shown in FIG. 2, the flat portion 183 has at its inner circumference a folded portion 185 folded frontward. The connecting member 180 is welded through the folded portion 185 to the outer circumference of the heater unit 150. In this embodiment, the flat portion 183 of the connecting member 180 is disposed within the cylindrical portion 122 of the cap member 120. The heater unit 150 is connected to the housing 130 through the connecting member 180, and the elasticity of the connecting member 180 allows the heater unit 150 to be displaced along the axis O. The connecting member 180 connecting the heater unit 150 to the housing 130 also plays a role in ensuring airtightness between a combustion chamber and the interior of the metallic shell 110.

The pressure sensor 160 (see FIG. 1) includes an annular metallic diaphragm 162 having at its center an opening 161 through which the inner shaft 170 passes, and a piezoresistor 164 joined to the upper surface (the rear end surface) of the metallic diaphragm 162. The metallic diaphragm 162 is formed of, for example, stainless steel. The integrated circuit 166 disposed at a prescribed position in the housing 130 is electrically connected to the piezoresistor 164. As described above, the rear end of the transmission sleeve 134 connected to the heater unit 150 is joined to the inner circumference of the metallic diaphragm 162. Therefore, when the heater unit 150 receives combustion pressure and is displaced along the axis O, the displacement or load generated as a result of the displacement is transmitted to the metallic diaphragm 162 through the transmission sleeve 134, and the metallic diaphragm 162 is thereby deformed. The integrated circuit 166 detects the deformation of the metallic diaphragm 162 by means of using the piezoresistor 164 to thereby detect the combustion pressure of the internal combustion engine. The integrated circuit 166 outputs an electric signal indicating the detected combustion pressure to, for example, an external ECU though the wires 116 inserted from the rear end of the metallic shell 110.

In the glow plug 100 of the present embodiment described above, the cap member 120 is formed of a high-strength metal higher in tensile strength (or yield strength) in a temperature range of −40° C. to 300° C. than a material used to form the metallic shell 110. Therefore, rigidity can be enhanced for the cap member 120 on which stress generated as a result of fastening the glow plug 100 is concentrated. Furthermore, in the present embodiment, the metallic shell 110 (a main metal member longer than the cap member 120) is formed of a high-thermal-expansion metal higher in thermal expansion coefficient in a temperature range of −40° C. to 150° C. than a material used to form the cap member 120. Therefore, thermal expansion of the metallic shell 110 can follow that of an engine head. By virtue of these features, even in the case of high combustion pressure in a combustion chamber or high thermal expansion coefficient of the engine head, airtightness between the combustion chamber and the glow plug 100 can be ensured without need to unnecessarily increase initial fastening axial force. Preferably, the cap member 120 is formed of a material having a tensile strength (or a yield strength) of 900 MPa or more in a temperature range of −40° C. to 300° C. Use of such a material can further enhance rigidity of the cap member 120. Preferably, the metallic shell 110 is formed of a material whose thermal expansion coefficient in a temperature range of −40° C. to 150° C. is two-thirds or more of the thermal expansion coefficient of a material used to form the engine head. Use of such a material can ensure sufficient airtightness between the combustion chamber and the glow plug 100.

Also, in the present embodiment, since the cap member 120 is formed of a high-strength metal, the thickness T1 of the cylindrical portion 122 can be smaller than the thickness T2 of the metallic shell 110. Therefore, the inside diameter B1 of the cylindrical portion 122 can be greater than the inside diameter B2 of the metallic shell 110, and the flat portion 183 of the connecting member 180 can thereby have an increased area. As a result, since the range of movement of the heater unit 150 along the axis O can be increased, performance (e.g., S/N ratio) of the pressure sensor 160 can be improved.

Also, the thickness T1 of the cylindrical portion 122 can be smaller than the thickness T2 of the metallic shell 110; in other words, the thickness T2 of the metallic shell 110 can be greater than the thickness T1 of the cylindrical portion 122. Thus, rigidity can be enhanced for the metallic shell 110 which is formed of a high-thermal-expansion metal in order to follow thermal expansion of the engine head. Therefore, even in the case of inability to utilize a steel having high thermal expansion and high strength (high tensile strength or high yield strength), by means of using materials having different characteristics to form the metallic shell 110 and the cap member 120, respectively, as in the case of the present embodiment, there can be restrained a deterioration in overall strength of the glow plug 100 and a reduction in fastening axial force during operation of an internal combustion engine.

One embodiment of the present invention has been described above. However, the present invention is not limited to the embodiment and may be embodied in various other forms without departing from the spirit of the invention. For example, the thickness T1 of the cap member 120 may be greater than the thickness T2 of the metallic shell 110. Also, the flat portion 183 of the connecting member 180 can be disposed within the metallic shell 110. In addition, the following modifications are possible.

In the above embodiment, the heater unit 150 is configured with the heat-generating coil 154 embedded in the sheath tube 152 but may be configured differently. For example, the heater unit 150 may be configured as a ceramic heater in which an electrically conductive ceramic is embedded in an electrically insulating ceramic.

In the above embodiment, the pressure sensor 160 is composed of the annular metallic diaphragm 162 and the piezoresistor 164. However, the configuration of the pressure sensor 160 is not limited thereto. Any well-known pressure sensor used for a glow plug with a combustion pressure sensor may be used in an appropriate manner.

In the above embodiment, the heater unit 150 is connected to the housing 130 through the connecting member 180 having the thin-film-like flat portion 183. However, for example, the heater unit 150 may be connected to the housing 130 through a bellows-like member.

In the above embodiment, the heater unit 150 is connected to the pressure sensor 160 through the transmission sleeve 134. However, the embodiment may be modified such that the rear end of the heater unit 150 is connected directly to the pressure sensor 160.

In the above embodiment, electric power is supplied to the heater unit 150 through the inner shaft 170. However, the inner shaft 170 may be omitted. Namely, the embodiment may be modified such that electric power is supplied from the wires 116 directly to the heater unit 150.

### DESCRIPTION OF REFERENCE NUMERALS

100: glow plug
110: metallic shell
112: tool engagement portion
114: threaded portion
116: wires
120: cap member
122: cylindrical portion
124: tapered portion
125: opening
126: corner
130: housing
132: sensor-fixing member
133: flange portion
134: transmission sleeve
150: heater unit
152: sheath tube
154: heat-generating coil
155: insulating powder
156: sealing member
160: pressure sensor
161: opening
162: metallic diaphragm
164: piezoresistor
166: integrated circuit
170: inner shaft
180: connecting member
182: flange portion
183: flat portion
184: cylindrical portion
185: folded portion
200: plug attachment hole
210: seat surface

1. A combustion pressure sensor-equipped glow plug comprising:
a housing having a tubular metallic shell extending in an axial direction and a tubular cap member which is provided at a front end of the metallic shell, which is shorter in length along the axial direction than the metallic shell, and whose diameter decreases toward a front end thereof;
a rod-shaped heater unit having a rear end portion disposed within the housing and a front end portion protruding from the front end of the cap member, the heater unit being movable in the axial direction;
a connecting member which connects the heater unit to the housing and allows the heater unit to move in the axial direction; and
a pressure sensor which detects combustion pressure according to load transmitted via the heater unit,
the combustion pressure sensor-equipped glow plug being characterized in that
the cap member is formed of a material higher in tensile strength or yield strength than a material used to form the metallic shell, and
the metallic shell is formed of a material higher in thermal expansion coefficient than that used to form the cap member.

2. A combustion pressure sensor-equipped glow plug according to claim 1, wherein
the cap member has a cylindrical portion formed at a rear end thereof, and
a thickness of the metallic shell is greater than a thickness of the cylindrical portion.

3. A combustion pressure sensor-equipped glow plug according to claim 2, wherein
an inside diameter of the cylindrical portion is greater than an inside diameter of the metallic shell, and
the connecting member is disposed in the cylindrical portion.
